(19) United States
(12) Patent Application Publication
(10) Pub. No.: US 2009/0163162 A1
(43) Pub. Date: Jun. 25, 2009

(54) DIRECT CONVERSION RECEIVING ARCHITECTURE WITH AN INTEGRATED TUNER SELF ALIGNMENT FUNCTION

(76) Inventors: Stephen W. Hoffman, Riverview, MI (US); Mohammed Sheikh-Movahhed, Ann Arbor, MI (US); J. William Whikehart, Milford, MI (US); Shaun D. Kalinowski, Van Buren Twp., MI (US)

Correspondence Address: VISTEON/BRINKS HOFER GILSON & LIONE, 524 South Main Street, Suite 200, Ann Arbor, MI, 48104, US

(21) Appl. No.: 11/959,929

(22) Filed: Dec. 19, 2007

(51) Int. Cl. H04B 17/00

(52) U.S. Cl. 455/226.1

(57) ABSTRACT

A direct conversion receiver with an integrated self alignment tuner. The system includes a tank circuit, an analog to digital converter, a digital down converter, a digital up converter, a local oscillator, and a digital to analog converter. The tank circuit receives a radio frequency signal from an antenna input. The analog to digital converter is connected to the tank circuit to digitize the tank output signal and generate a corresponding digital signal. The digital down converter is in communication with the analog to digital converter and generates an intermediate frequency signal based on the digital signal and the output of the local oscillator. The digital up converter is in communication with the digital to analog converter to generate a radio frequency test signal, where the digital to analog converter provides the radio frequency test signal to the antenna input.

### BACKGROUND

1. Field of the Invention

The present invention generally relates to a radio receiver and alignment of the tuner.

2. Description of Related Art

Currently an important, time consuming, and potentially expensive element to manufacturing a radio receiver is the plant tuner calibration. The plant tuner calibration is the step in the manufacturing process that aligns the front end circuitry of the receiver such that the receiver has optimal channel sensitivity and maximum undesired channel suppression. The calibrating equipment necessary to automatically align the front end circuitry is expensive, both in terms of initial capital and maintenance costs, and requires valuable floor space.

The problem is currently solved through the use of a tuner alignment station in the manufacturing plant. This tuner alignment station utilizes, at the very least, a dedicated external RF signal generator and, possibly, a computer and voltage measurement device to align the tuner. Typically, once the tuner parameters are determined, they are stored in the radio receiver and remain unchanged for the life of the radio.

In view of the above, it is apparent that there exists a need for a direct conversion receiver with an integrated self alignment tuner.

### SUMMARY

In satisfying the above need, as well as overcoming the enumerated drawbacks and other limitations of the related art, the present invention provides a direct conversion receiver with an integrated self alignment tuner.

The system generally includes a tank circuit, an analog to digital converter, a digital down converter, a digital up converter, a local oscillator, and a digital to analog converter. The tank circuit is in communication with an antenna input to receive a radio frequency signal. The analog to digital converter is connected to the tank circuit to digitize the tank output signal and generate a digital signal corresponding to the tank output signal. The local oscillator is in communication with both the digital down converter and the digital up converter. The digital down converter is in communication with the analog to digital converter and configured to generate an intermediate frequency signal based on the digital signal and the output of the local oscillator. The digital up converter is in communication with the digital to analog converter to generate a radio frequency test signal, where the digital to analog converter provides the radio frequency test signal to the antenna input. In a self alignment mode, the intermediate frequency signal may be monitored, as the tuning voltage is varied, to determine the optimal tuning voltage for the radio frequency test signal.

Integrating the necessary hardware for “self alignment” of the tuner can result in additional component costs. However, little additional hardware is necessary for self alignment in a direct conversion receiver design. Therefore, self alignment in a direct conversion receiver is less costly than in a comparable receiver that digitizes at the intermediate frequency (IF). Since the direct conversion architecture already includes the mixing frequencies necessary to mix the radio frequency (RF) signal to baseband, the only additional hardware required to produce an RF test signal at the appropriate frequency are a digital to analog converter (DAC) and some input/output (I/O) logic within the digital down converter. In addition, the DAC can be implemented using a low cost design depending on the level of accuracy required, using the principles of undersampling and image frequencies to produce a carrier wave at the desired test frequencies. In addition the DAC accuracy can be relatively low because the test signal it creates is only being used for the alignment process and does not need to support the quality necessary for high quality audio output. If required, a modulated signal can be produced with the addition of a digital modulator, thereby allowing more complex internal testing and calibration procedures, such as aligning adjacent channel detectors, modulation detectors, testing radio data system (RDS) functionality, etc.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic illustration of one embodiment of a direct conversion receiver with an integrated self alignment tuner;

FIG. 2 is a graph illustrating one procedure for tuning a receiver; and

FIG. 3 is a graph illustrating another procedure for tuning a receiver.

### DETAILED DESCRIPTION

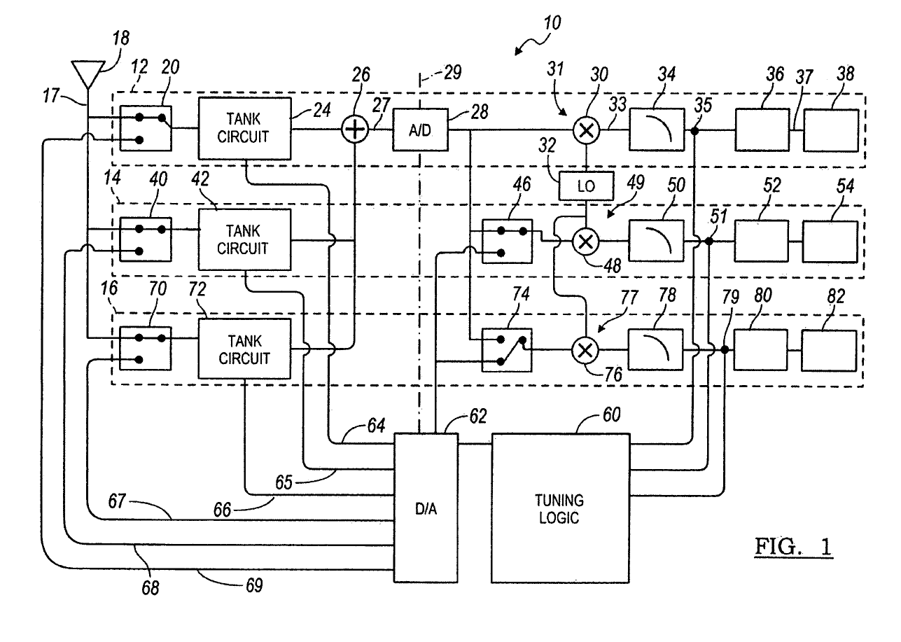

Referring now to FIG. 1, a system 10 with a direct conversion receiver and integrated self alignment capability is provided. The system 10 includes three channels 12, 14, 16, although, one of ordinary skill in the art would understand that additional channels may also be integrated into this architecture. Multiple channels may be useful for channel scanning, adjacent channel detectors, RDS detectors, or in-band on-channel (IBOC) detectors. As such, multiple channels allow the radio receiver to monitor various conditions in the radio environment to provide information to the user or prepare for a user initiated change while providing continuous audio output to the user. The system 10 includes an antenna 18 that is in communication with each of the channels, 12, 14, and 16. The first channel 12 includes a switch 20 that selectively connects a tank circuit 24 to the antenna 18 or a test signal 69. Under normal operation, the tank circuit 24 will be connected to the antenna 18 through the switch 20 to receive an RF radio signal 17.

The tank circuit 24 acts as a band pass filter to provide a portion of the RF signal 17 at the tuned frequency. The tank circuit 24 may take the form of any known tank circuit. In one embodiment, the tank circuit 24 may include a varactor diode that acts as a variable inductor. The varactor diode is tuned by an analog tuning voltage that controls the center or frequency of the tank circuit 24. Although, other methods to control the characteristics of the tank circuit 24 may be used. Since the ideal analog tuning voltage output necessary to center the tank circuit 24 varies over the FM frequency band, the output must change depending on which FM frequency the radio is tuned to. Therefore, during a typical plant tuner calibration, an external RF generator is set to multiple frequencies across the FM band. At each of those frequencies, the ideal tuning voltage, which centers the tank response about that frequency, is identified. Then, the identified analog tuning voltage is recorded. Since it would be too time consuming to record the proper DC voltage for every channel within the FM band during the plant calibration, an algorithm in the radio's microprocessor extrapolates the proper analog tuning voltage associated with each tuned frequency that falls between the known calibrated tuning voltages.

The tank circuit 24 is in communication with a summer 26. The summer 26, shown as part of channel 12, also receives tuned frequencies from the other channels 14, 16 and combines the signals to provide a combined radio frequency signal 27 including the tuned frequencies from each channel. The summer 26 provides the combined radio frequency signal 27 to the analog to digital converter 28. A single analog to digital converter 28 is utilized in the shown architecture to reduce the cost of the system 10, as the analog to digital converter 28 is typically a high cost component within the architecture. However, one of ordinary skill in the art could understand that multiple analog to digital converters can be used independently in each channel and, as such, the summer 26 may be eliminated.

The signal from the analog to digital converter 28 is a digital signal that is provided to a mixer 30. It may be helpful to note that in a direct conversion architecture that the signals to the left of line 29 occur in an analog domain while the signals to the right of line 29 occur in a digital domain. As such, each of the components to the right of line 29 may be implemented as a method and imbedded as instructions stored in a memory or other computer readable medium. The mixer 30 is in communication with a local oscillator 32 to generate an intermediate frequency signal 33 that is provided to the low pass filter 34. The local oscillator 32 may be implemented in software and may take the form of a numeric controlled oscillator. As such, the local oscillator 32 generates a digitized oscillation signal. In conjunction with a low pass filter 34, the mixer 30 and the local oscillator 32 function as a digital down converter, as denoted by reference number 31. The intermediate frequency signal 35 is provided to a demodulator 36, and the demodulator 36 generates an audio signal 37 that is provided to an audio output device 38.

The intermediate frequency signal 35 generated by the digital down converter 31 is also provided to the tuning logic block 60. Within the tuning logic block 60, the intermediate frequency signal 35 may be utilized for self-aligning the tank circuit 24. As such, the tuning logic 60 determines the maximum output level of the intermediate frequency signal 35 as the tuning voltage or input frequency is varied. Alternatively, the tuning logic 60 may record the response of the intermediate frequency signal 35 as a tuning voltage or an input frequency is altered, allowing the response to be stored in memory and analyzed in more detail. As described above, the tuning logic 60 provides a signal to a digital to analog converter 62 to generate an analog tuning voltage 64 that is provided to the tank circuit 24. Analog tuning voltage 64 determines the center frequency for the band pass filter implemented by the tank circuit 24. In one implementation, the tuning voltage 64 sets the center of the band pass filter based on the highest output level of the intermediate frequency signal 35.

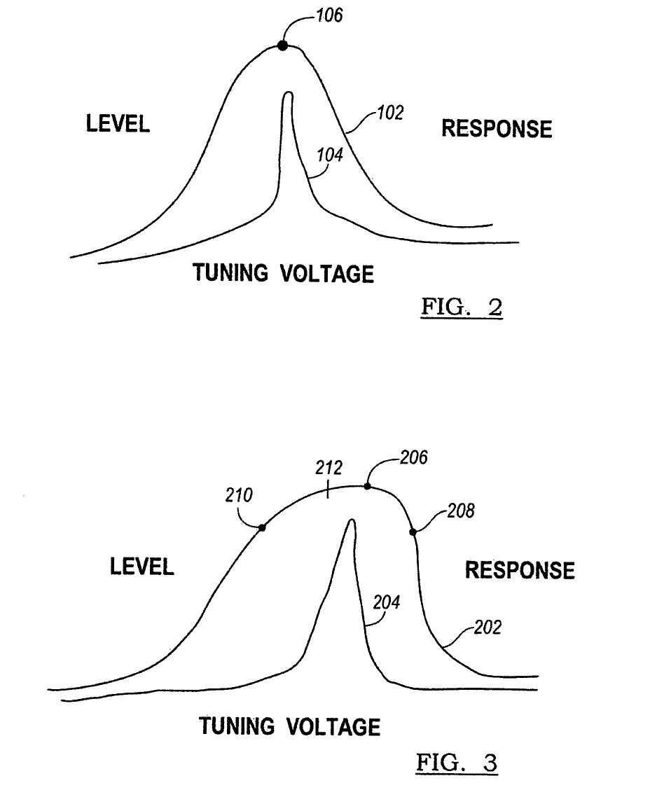

One illustration of this method is provided in FIG. 2. Line 102 represents the output level of the band pass filter generated by the tank circuit 24. Line 104 represents the level of the intermediate frequency signal 35 as it varies with respect to the tuning voltage 64 that is provided to the tank circuit 24. As such, the maximum level of the intermediate frequency signal 35 is matched to the tuning voltage 64 and stored in the radio receiver. Frequency-tuning voltage pairings are stored in the radio tuner thereby providing a relationship between the analog tuning voltage 64 and the particular characteristics of the tank circuit 24 for the desired frequency. As one of ordinary skill in the art would recognize, the tuning voltage may be varied for a fixed frequency or, alternatively, as described above for the bench alignment systems, the frequency may be varied for a fixed tuning voltage to generate the frequency tuning voltage pairings.

Another method for aligning the receiver is shown in FIG. 3. As illustrated in FIG. 3, the characteristics of the tank circuit 24 may generate an asymmetric band pass filter. As such, multiple points may be measured along the range of tuning voltage values to determine the frequency-tuning voltage pairing. Line 204 represents the intermediate frequency signal 35 for a range of tuning voltage values, while line 202 represents the band pass filter response of the tank circuit 24. Similar to FIG. 2, the maximum level of the intermediate frequency signal 35 may be determined and is shown as 206 on line 202. However, the band pass filter response 202 is skewed to the right. As such, multiple points may be measured along the response curve to determine the selected tuning voltage for the desired frequency. For example, the two locations on the curve corresponding to a predefined attenuation level (for example, −3 dB attenuation) from the maximum level 206 may be determined as denoted by 210, 208. As such, a representative tuning voltage 212 may be selected based on the attenuation points 210 and 208. In one example, a curve fit may be applied to the points to determine the average signal across the range. Alternatively, an interpolation between the two −3 dB points 210 and 208 may be used for simplicity.

As mentioned above, one of the channels may be used as a digital up converter to generate the test frequency signal. Switch 74 allows the local oscillator 32 and a mixer 76 to be utilized to generate a frequency test signal that is provided to the digital to analog converter 62. As such, the mixer 76 and local oscillator 32 function as a digital up converter, as denoted by reference number 77. The digital to analog converter 62 may convert the digitized test signal to an analog test signal and provide the test signal to any of the first, second, or third channels 12, 14, 16 as denoted by test signals 67, 68, and 69. Accordingly, the switches 20, 40, and 70 may be manipulated by the tuning logic 60 to provide a test signal to the first, second or third channels 12, 14, or 16.

In one specific example, the second channel 14 receives the test signal 68, which is selectively provided to the tank circuit 42 of channel 14 through switch 40. As such, the tank circuit 42 may receive the RF radio signal 17 in a normal operation mode or be switched to the test signal 68 in a self-alignment mode. The tank circuit 42 provides a tuned RF signal to the summer 26 to generate the combined RF signal 27 that is digitized by the analog to digital converter 28. The digitized component of the combined radio frequency signal 27 that corresponds to the output of the tank circuit 42 is provided to a mixer 48 through the switch 46. In a normal mode of operation, the mixer 48 combines the corresponding portion of the digital signal from the tank circuit 42 with the signal from the local oscillator 32 to generate a signal that is provided to a low pass filter 50. The low pass filter 50 produces an intermediate frequency signal 51 that is provided to a demodulator 52. The demodulator 52 generates an audio signal that is then provided to an audio output device 54. In addition, the intermediate frequency signal 51 is provided to the tuning logic block 60 allowing the tuning logic block 60 to determine the maximum output level of the intermediate frequency signal 51 as the tuning voltage 65 is varied on the second channel 14. It should be additionally noted that the pre-filtered intermediate frequency signal may also be used.

Further, the local oscillator 32 and mixer 48 may be used in conjunction with a switch 46 in a self alignment mode to provide a test frequency signal to the digital to analog converter 62. In this manner, the local oscillator 32 functions in the same manner as in the normal mode, except that rather than mixing the local oscillator output with the signal from the tank circuit 42, the switch 46 provides the local oscillator output to the digital analog converter 62. The digital to analog converter 62 in turn generates a test signal for the first or third channels 12, 16, as denoted by test signals 67 and 69.

In addition, the tank circuit 42 receives a tuning voltage 65 from the digital to analog converter 62 based on the tuning logic 60. During normal operation, the tuning logic 60 calculates the appropriate tuning voltage based on the desired frequency and the stored relationship between the tuning voltage and tank circuit response. However, in a self-aligning mode the tuning logic 60 varies the tuning voltage 65 based on the intermediate frequency 51, as discussed above with respect to the intermediate frequency signal 35 in the first channel 12.

Similar to the second channel 14, the third channel 16 receives the test signal 67 that is selectively provided to a tank circuit 72 through switch 70. As such, the tank circuit 72 may receive the RF radio signal 17 in a normal operation mode or the test signal 67 in a self-alignment mode. The tank circuit 72 provides a tuned RF signal to the summer 26 to generate the combined RF signal 27 that is digitized by the analog to digital converter 28. The digitized component of the combined radio frequency signal 27 that corresponds to the output of the tank circuit 72 is provided to the mixer 76 through switch 74. In a normal mode of operation, the mixer 76 combines the corresponding portion of the digital signal from the tank circuit 72 with the signal from the local oscillator 32 to generate a signal that is provided to a low pass filter 78. The low pass filter 78 produces an intermediate frequency signal 79 that is provided to a demodulator 80, which generates an audio signal that is then provided to an audio output device 82.

In addition, the tank circuit 72 receives a tuning voltage 66 from the digital to analog converter 62 based on the tuning logic 60. As with the other channels, during normal operation, the tuning logic 60 calculates the appropriate tuning voltage based on the desired frequency and the stored relationship between the tuning voltage and tank circuit response. However, in a self-alignment mode the tuning logic 60 varies the tuning voltage 66 based on the intermediate frequency signal 79, as also discussed above with respect to the intermediate frequency 35 in the first channel 12.

While self-aligning the first and second channels 12, 14, the local oscillator 32 and mixer 76 may be used in conjunction with a switch 74 in a self-alignment mode to provide a test frequency signal to the digital to analog converter 62. In this manner, the local oscillator 32 functions in the same manner as in the normal mode, except that rather than mixing the local oscillator output with the signal from the tank circuit 72, the switch 74 provides the local oscillator output to the digital to analog converter 62. The digital to analog converter 62 in turn generates a test signal for the first or second channels 12, 14, as denoted by test signals 68 and 69.

As such, the mixers 30, 48, 76 and the oscillator 32 are processing resources used for both normal audio processing, as well as, a special alignment function. Therefore, with an intelligent reconfiguration of these resources a built in alignment function can be provided in a cost effective manner.

The embodiments described above encompass a direct conversion receiver design with an integrated tuner having a self aligning function, and, therefore, the alignment is independent of most external influences. The alignment function is dependant on the radio having a power source and proper grounding, but does not require an external test frequency. Similar to current plant tuner alignment, a specified amount of time will be allocated to allow the procedure to successfully complete. In addition the RF environment which is present during the receiver's alignment must be taken into consideration as well.

In other alternative embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

We claim:

1. A radio system with self alignment, the system comprising:
a tank circuit in communication with an antenna input;
an analog to digital converter connected to the tank circuit to digitize a tank output signal and generate a digital signal corresponding to the tank output signal;
a digital down converter in communication with the analog to digital converter and configured to receive the digital signal;
a digital up converter configured to generate a radio frequency test signal;
a local oscillator forming part of the digital down converter and the digital up converter to provide a mixing frequency; and
a digital to analog converter in communication with the digital up converter and configured to provide the radio frequency test signal to the antenna input.

2. The radio system according to claim 1, further comprising a control module in communication with the tank circuit to provide a tuning voltage signal to the tank circuit.

3. The radio system according to claim 2, wherein the control module is in communication with the digital down converter to receive an intermediate frequency signal.

4. The radio system according to claim 3, wherein the control module determines a level of the tuning voltage signal that provides a maximum amplitude in the intermediate frequency signal.

5. The radio system according to claim 3, wherein the control module determines a plurality of amplitudes for the intermediate frequency signal corresponding to a plurality of levels of the tuning voltage signal.

6. The radio system according to claim 3, wherein the control module is configured to determine a maximum intermediate frequency signal output over a voltage range of the tuning voltage signal.

7. The radio system according to claim 6, wherein the plurality of amplitudes include a first amplitude corresponding to the maximum amplitude, a second amplitude corresponding to a predefined attenuation level and a third amplitude corresponding to the predefined attenuation level.

8. The radio system according to claim 1, further comprising a modulator in communication with the digital up converter.

9. The radio system according to claim 2, wherein the control module is configured to store a table of a signal frequency and a corresponding level of tuning voltage signal that provides the maximum intermediate frequency signal output.

10. The radio system according to claim 1, wherein the local oscillator is a numeric controlled oscillator.

11. A method for aligning a radio system, the method comprising the steps of:
providing a tank circuit in communication with an antenna input;
digitizing a tank output signal;
converting the tank output to a intermediate frequency signal;
generating a digitized oscillation signal;
converting the digitized oscillation signal to a digitized test signal;
generating an analog test signal based on the digitized test signal;
providing the analog test signal to the antenna input.

12. The method according to claim 11, further comprising providing a tuning voltage signal to the tank circuit.

13. The method according to claim 11, further comprising monitoring an intermediate frequency signal.

14. The method according to claim 12, further comprising determining a level of the tuning voltage signal that provides a maximum amplitude in the intermediate frequency signal.

15. The method according to claim 12, further comprising determining a plurality of amplitudes for the intermediate frequency signal corresponding to a plurality of levels of the tuning voltage signal.

16. The method according to claim 12, further comprising determining a maximum intermediate frequency signal output over a voltage range of the tuning voltage signal.

17. The method according to claim 16, wherein the plurality of amplitudes include a first amplitude corresponding to the maximum amplitude, a second amplitude corresponding to a predefined attenuation level and a third amplitude corresponding to the predefined attenuation level.

18. The method according to claim 12, further comprising storing a table of a signal frequency and a corresponding level of tuning voltage signal that provides a maximum intermediate frequency signal output.
